(19) United States
(12) Patent Application Publication
(10) Pub. No.: US 2018/0083281 A1
(43) Pub. Date: Mar. 22, 2018

(54) BORON-DOPED ACTIVATED CARBON MATERIAL

(71) Applicant: NEC CORPORATION, Tokyo (JP)

(72) Inventors: Qian CHENG, Tokyo (JP); Noriyuki TAMURA, Tokyo (JP)

(73) Assignee: NEC CORPORATION, Tokyo (JP)

(21) Appl. No.: 15/561,379

(22) PCT Filed: Mar. 27, 2015
(86) PCT No.: PCT/JP2015/060531

§ 371 Date: Sep. 25, 2017

(51) Int. Cl. H01M 4/587; H01M 4/133; H01M 10/0525; C01B 32/05

(52) U.S. Cl. CPC H01M 4/587; H01M 4/133; H01M 2004/021; C01B 32/05; H01M 10/0525

(57) ABSTRACT

An anode material for a lithium ion secondary battery that is obtainable by a method comprising: preparing a raw material of the anode material selected from high oxygen containing carbons, heat treating the raw material at a temperature of 550° C. to 850° C. under oxidizing atmosphere to form having a multi-channel carbon material and doping boron into the multi-channel carbon material.

### TECHNICAL FIELD

The present invention relates to a boron-doped activated carbon material used as an anode material for a high capacity and fast chargeable lithium-ion battery.

### BACKGROUND ART

Lithium-ion (Li-ion) batteries have been widely used for portable electronics, and they are being intensively pursued for hybrid vehicles (HVs), plug-in hybrid vehicles (PHVs), electric vehicles (EVs), and stationary power source applications for smarter energy management systems. The greatest challenges in adopting the technology for large-scale applications are to improve energy density, power density, and cycle life of current electrode materials in addition to cost and safety. Of all the properties, a charging time is the most important characteristics for the battery as well as the power density, especially as the application targets of Li-ion batteries shift from small mobile devices to transportation. This is because EV users, for example, are hardly to wait more than half an hour for charging their vehicles during a long drive compared with a refueling period of less than 5 minutes for gasoline cars. The charging speed greatly depends on a lithiation rate capability of the anode material.

At present, graphite is the most popular and practical anode material for Li-ion batteries because of its low cost, high capacity, relatively long cycle life, and ease of processing. However, due to its small interlayer space (0.335 nm), lack of Li-ion intercalation site on its basal plane and a long diffusion path length through a lot of graphite interlayers, graphite results in a limited lithiation rate capability. Amorphous carbons such as soft carbon and hard carbon usually have larger interlayer spaces than graphite, offering a faster lithium input rate than graphite. However, soft carbon usually has a limited capacity (around 250 mAh/g) and high average potential at charging and discharging, it is difficult to use in Li-ion batteries with high energy density. Hard carbon has a capacity around 400 mAh/g, but its low density, low coulombic efficiency, and high cost make it difficult to use in batteries for EVs and PHVs at a low cost. Other high capacity anode materials such as silicon and tin alloys have even worse lithiation rate capabilities because of low kinetics of lithium alloying and the accessibility of lithium ion through thick solid-electrolyte-interface (SEI). There are some attempts such as JP2014-130821A and JP10-188958 A, which tried to add some additional elements such as boron in order to increase the capacity of the carbon materials. However, they did not get anode materials having both fast charging capability, high capacity as well as long cyclability. In summary, there is no anode material, which can satisfy the high capacity, fast charging capability and sufficiently long cyclability for lithium ion battery, up to now.

A porous carbon material having high specific surface area in high yield at a low cost by an oxidizing gas activation method is proposed in JP 2001-302225A. This porous carbon material is produced by heating a soft carbon material in the presence of oxygen at a temperature lower than the activation temperature and activating the obtained pretreated product with an oxidizing gas. The pretreatment is preferably carried out at 200-500° C. A porous carbon material having a specific surface area of 1,000 m²/g or higher and usable as an electrode material for an electric double layer capacitor having high electrical capacitance can be produced by the process. Thus porous carbon material having high specific surface area is not suitable for the anode material of LIBs. Carbon material used as the anode material of LIBs usually has a low specific surface area of less than 40 m²/g, preferably 20 m²/g or less, more preferably 10 m²/g or less because of suppressing side reactions at charging and discharging.

### SUMMARY OF THE INVENTION

In order to solve these problems, a new material is proposed to improve the capacity and rate capability of anode materials by means of surface activation and boron doping.

That is, one aspect of the present invention provides a process for manufacturing an anode material for a lithium ion battery including:

preparing a raw material of the anode material selected from high oxygen containing carbons;

heat treating the raw material at a temperature ranging from 550° C. to 850° C. under oxidizing atmosphere to form a multi-channel carbon material; and

doping boron into the multi-channel carbon material.

Another aspect of the present invention provides an anode material for a lithium-ion battery including a carbon material wherein the carbon material includes a plurality of pores or holes with the depth between 100 nm and 3 μm inclusive on the surface; the carbon material is doped with 0.5 to 5% by weight of borons; and the carbon material has an interlayer space between 0.3470 nm and 0.36 nm inclusive.

Still another aspect of the present invention provides a lithium ion battery including the above anode material.

One aspect of the present invention can provide an anode material for a lithium ion battery that is excellent in capacity, rate capability as well as cyclability.

### BRIEF DESCRIPTION OF THE DRAWINGS

FIGS. 1A and 1B show SEM images of a carbon material for Comparative Example 1.

FIGS. 2A and 2B show SEM images of a carbon material for Example 1.

FIG. 3 shows a graph of rate capabilities in Reference Example 2, Comparative Example 2 and Example 1.

FIG. 4 shows charging and discharging curves of LIBs in Comparative Examples 1 and 2, and Example 1.

FIG. 5 shows a graph of cyclabilities of LIBs in Example 1 and Reference Example 2

### MODES FOR CARRYING OUT THE INVENTION

The present invention provides an anode material comprising a carbon material with a multi-channel structure to activate the basal plane of the carbon material; more specifically it has pores and holes on the surface of the carbon material after activation. Generally, conventional carbon material such as graphite has a relatively smooth surface of basal plane, which is hard to intercalate lithium ions. The multi-channel structure can provide to increase lithium ion intercalation sites on the surface, which are advantageous for the fast charging property.

Regarding to the holes and pores, they are preferably formed on the basal plane at which a lot of defects or micro pores are formed. After air oxidation, the defects or micro pores are etched and as a result, a lot of deeply large pores and holes can be developed on the basal plane of the carbon material. The depth of the pore or hole can be 100 nm or more, preferably 500 nm or more, most preferably between 1 μm and 3 μm inclusive. These deeply large pores and holes can increase the lithium ion intercalation and de-intercalation sites and reduce a length of the lithium ion diffusion path so as to provide a fast charging-discharging property.

For the density of pores or holes, it is sufficient to increase the rate capability if the density is not less than 1 pore or hole per μm². However, the extremely high density will cause more increase of the surface area resulting in increase of unfavorable side reactions with an electrolyte.

For the distribution of pores or holes, it is preferred to have 1 to 5 μm of a distance between adjacent pores or holes. It is the most preferred to uniformly distribute the pores or holes on the surface of the carbon material for a better rate capability.

This invention also proposes boron doping on the carbon material for increasing capacity of the anode material. The boron doping can realize a reversible reaction with lithium ions to provide an additional capacity besides lithium ion intercalation. As a result, the capacity of the anode material can be increased. The doped boron is preferably implanted in a region deeper than 50 nm from the uppermost surface of the carbon material.

Hereinafter, the boron doped carbon material having the multi-channel structure is also referred to as “multi-channel B doped carbon material.”

Regarding to the quantity of the doped boron, it is preferred to have 0.5% by weight or more of boron, more preferably 1.5% by weight or more, most preferably 2.5% by weight or more. The quantity of the doped boron is preferably 5% by weight or less, more preferably 4.5% by weight or less, and most preferably 4% by weight or less.

The status of the doped boron atom can be an exotic atom, or boron containing functional groups, such as groups including C—B bond and/or B—N bond, —B(OH)₂, or the like.

The multi-channel B doped carbon material preferably further includes an anode active particle which is capable of absorbing and desorbing lithium ions. Examples of the anode active particles include: (a) metal or semi-metal particles of silicon (Si), germanium (Ge), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements, wherein the alloys or intermetallic compounds are stoichiometric or nonstoichiometric; (c) oxides, carbides, nitrides, sulfides, phosphides, selenides, and tellurides of Si, Ge, Sn, Pb, Sb, Bi, Zn, Al, Fe, Ti, Ni, Co, or Cd, and their mixtures or composites; and (d) combinations thereof. There is essentially no constraint on the type and nature of the anode active particles that can be used in practicing the present invention. Among them, metal or semi-metal particles or compound particles of at least one element selected from a group consisting of Si, Sn, Al, Ge and Pb are preferable.

The multi-channel B doped carbon material can be coated with a thin layer of amorphous carbon after combining with the anode active particles, such as Si, Sn, etc. For instance, micron-, sub-micron-, or nano-scaled particles or rods, such as SnO₂ nano particles, may be decorated on the surface of the multi-channel B doped carbon material to form a composite material. Then the composite material can be coated with the thin layer of amorphous carbon by pyrolysis of hydrocarbons such as sugar or using CVD method. The thickness of the thin layer is preferably 2 nm to 15 nm.

### Fabrication Method

The fabrication procedure of the multi-channel B doped carbon materials for the present embodiment is described as follows:

1) Preparation of a Raw Material of the Anode Material

A raw material selected from high oxygen containing carbons is prepared. The raw material can be selected from particles of high oxygen containing carbon materials, such as graphite oxide, air oxidized graphite, green cokes, graphene oxide and any other high oxygen containing carbon materials. The raw carbon material can be used singly or in combination thereof. The particle size of the carbon material is preferably from 10 μm to 25 μm.

2) Activation to Form a Multi-Channel Structure

The raw material is heat treated at a temperature ranging from 550° C. to 850° C. under oxidizing atmosphere to form a carbon material having a multi-channel structure. The oxidizing atmosphere can be selected from oxygen (O₂), ozone (O₃), carbon monoxide (CO), nitrogen oxide (NO), steam (H₂O) and air. The activation is preferably carried out in air. The heat treatment can be carried out for 0.5 to 3 hours.

3) Boron Doping

The activated carbon material is then mixed with a boron containing compound such as boric acid, boron oxide and the like. A mixing ratio of the activated carbon material and the boron containing compound is 1:05 to 1:1 in term of mole ratio. The mixing can be carried out by dry mixing or wet mixing. The resultant mixture is then heat treated to decompose the boron containing compound. The heat treatment can be carried out at higher than the decomposition temperature of the boron containing compound, preferably at 200° C. or higher, more preferably at 300° C. or higher. This heat treatment is carried out under non-oxidizing atmosphere such as nitrogen atmosphere or inert gas atmosphere. The nitrogen atmosphere is preferred. Specifically, the heat treatment can be performed by a multi-step heating process. The multi-step heating process can include three-step heating of a first heating step at a temperature ranging from 250° C. to 350° C., a second heating step at a temperature ranging from 400° C. to 650° C. and a third heating step at a temperature ranging from 650° C. to 900° C. The first to third heating steps can be performed for 1 to 3 hours, 1 to 3 hours and 2 to 6 hours, respectively.

The resultant material is washed with water and dried in vacuum oven for 2 to 24 hours.

Thus obtained multi-channel B doped carbon material has relatively higher interlayer space by doping boron. Theoretical interlayer space (interplane space of d₀₀₂) of graphite is 0.335 nm and the interlayer space of the multi-channel B doped carbon material is preferably 0.3470 nm or more. However, exceeded interlayer space is not preferable and the interlayer space of the multi-channel B doped carbon material is preferably 0.360 nm or less. The interlayer space is controllable by doping quantity, heat temperature, heating time or the like. The interlayer space is determined by X-ray diffraction.

The specific surface area of the multi-channel B doped carbon material is preferably 10 m²/g or less, more preferably 5 m²/g or less. The specific surface area is preferably 1 m²/g or more, more preferably 2 m²/g or more. The specific surface area is determined by BET surface area analysis.

### Lithium Ion Battery (LIB)

The multi-channel B doped carbon material as stated above can be employed for an anode material for a lithium ion secondary battery (LIB). The LIB includes a positive electrode including a positive electrode active material (cathode material) and a negative electrode including the anode material. The anode material of the present exemplary embodiment has high capacity of at least 500 mAh/g.

As for the positive electrode active material, but there is also no particular restriction on the type or nature thereof, known cathode materials can be used for practicing the present invention. The cathode materials may be at least one material selected from the group consisting of lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphates, metal sulfides, and combinations thereof. The positive electrode active material may also be at least one compound selected from chalcogen compounds, such as titanium disulfate or molybdenum disulfate. More preferred are lithium cobalt oxide (e.g., LiₓCoO₂ where 0.8≦x≦1), lithium nickel oxide (e.g., LiNiO₂) and lithium manganese oxide (e.g., LiMn₂O₄ and LiMnO₂) because these oxides provide a high cell voltage. Lithium iron phosphate is also preferred due to its safety feature and low cost. All these cathode materials can be prepared in the form of a fine powder, nano-wire, nano-rod, nano-fiber, or nano-tube. They can be readily mixed with an additional conductor such as acetylene black, carbon black, and ultra-fine graphite particles.

For the preparation of an electrode, a binder can be used. Examples of the binder include polytetrafluoroethylene (PTFE), polyvinylidene fluoride (PVDF), ethylene propylenediene copolymer (EPDM), or styrene-butadiene rubber (SBR). The positive and negative electrodes can be formed on a current collector such as copper foil for the negative electrode and aluminum or nickel foil for the positive electrode. However, there is no particularly significant restriction on the type of the current collector, provided that the collector can smoothly path current and have relatively high corrosion resistance. The positive and negative electrodes can be stacked with interposing a separator therebetween. The separator can be selected from a synthetic resin nonwoven fabric, porous polyethylene film, porous polypropylene film, or porous PTFE film.

A wide range of electrolytes can be used for manufacturing a cell. Most preferred are non-aqueous and polymer gel electrolytes although other types can be used. The non-aqueous electrolyte to be employed herein may be produced by dissolving an electrolyte (salt) in a non-aqueous solvent. Any known non-aqueous solvent which has been employed as a solvent for a lithium secondary battery can be employed. A mixed solvent comprising ethylene carbonate (EC) and at least one kind of non-aqueous solvent whose melting point is lower than that of ethylene carbonate and whose donor number is 18 or less (hereinafter referred to as a second solvent) may be preferably employed as the non-aqueous solvent. This non-aqueous solvent is advantageous in that it is (a) stable against a negative electrode containing a carbonaceous material well developed in graphite structure; (b) effective in suppressing the reductive or oxidative decomposition of electrolyte; and (c) high in conductivity. A non-aqueous solvent solely composed of ethylene carbonate (EC) is advantageous in that it is relatively stable against decomposition through a reduction by a graphitized carbonaceous material. However, the melting point of EC is relatively high, 39-40° C., and the viscosity thereof is relatively high, so that the conductivity thereof is low, thus making EC alone unsuited for use as a secondary battery electrolyte to be operated at room temperature or lower. The second solvent to be used in the mixed solvent with EC functions to make the viscosity of the mixed solvent lowering than that of which EC is used alone, thereby improving an ion conductivity of the mixed solvent. Furthermore, when the second solvent having a donor number of 18 or less (the donor number of ethylene carbonate is 16.4) is employed, the aforementioned ethylene carbonate can be easily and selectively solvated with lithium ion, so that the reduction reaction of the second solvent with the carbonaceous material well developed in graphitization is assumed to be suppressed. Further, when the donor number of the second solvent is controlled to not more than 18, the oxidative decomposition potential to the lithium electrode can be easily increased to 4 V or more, so that it is possible to manufacture a lithium secondary battery of high voltage. Preferable second solvents are dimethyl carbonate (DMC), methyl ethyl carbonate (MEC), diethyl carbonate (DEC), ethyl propionate, methyl propionate, propylene carbonate (PC), γ-butyrolactone (γ-BL), acetonitrile (AN), ethyl acetate (EA), propyl formate (PF), methyl formate (MF), toluene, xylene and methyl acetate (MA). These second solvents may be employed singly or in a combination of two or more. More desirably, this second solvent should be selected from those having a donor number of 16.5 or less. The viscosity of this second solvent should preferably be 28 cps or less at 25° C. The mixing ratio of the aforementioned ethylene carbonate in the mixed solvent should preferably be 10 to 80% by volume. If the mixing ratio of the ethylene carbonate falls outside this range, the conductivity of the solvent may be lowered or the solvent tends to be more easily decomposed, thereby deteriorating the charge/discharge efficiency. More preferable mixing ratio of the ethylene carbonate is 20 to 75% by volume. When the mixing ratio of ethylene carbonate in a non-aqueous solvent is increased to 20% by volume or more, the solvating effect of ethylene carbonate to lithium ions will be facilitated and the solvent decomposition-inhibiting effect thereof can be improved.

### EXAMPLE

### Reference Example 1 (Raw Material)

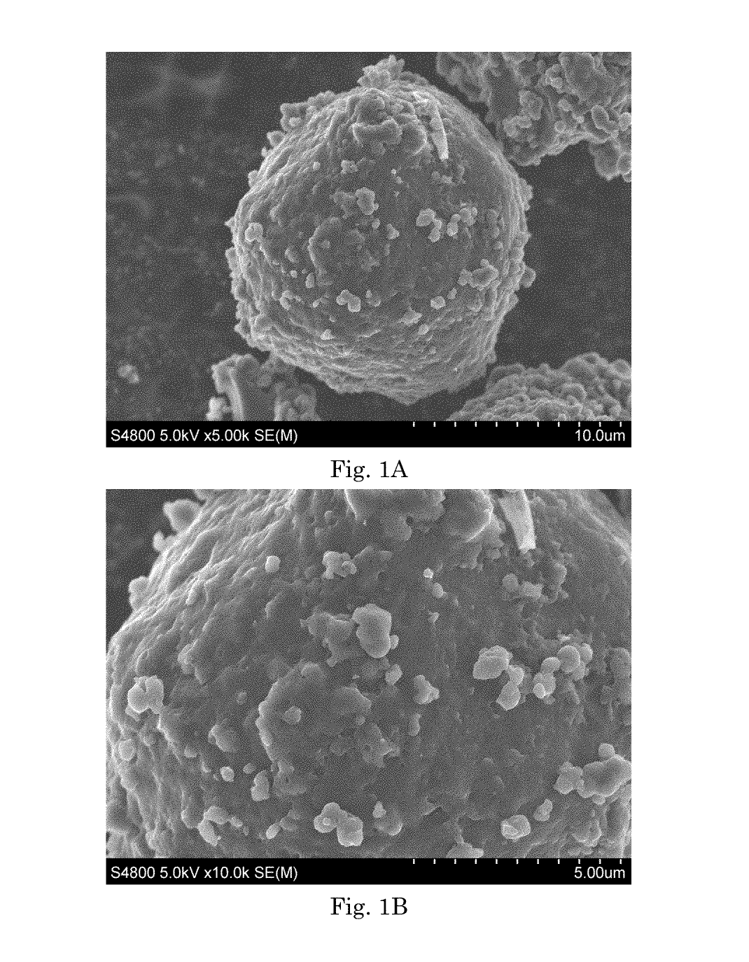

Green cokes having particle diameter of about 13 μm without any treatment was used as a carbon material for reference example 1. Scanning electron microscopic (SEM) images of the carbon material are shown in FIGS. 1A (5,000 magnifications) and 1B (10,000 magnifications). The raw material has a relative smooth surface before any treatment.

### Reference Example 2 (Graphite)

Granulated graphite having diameter of about 15 μm without any treatment was used as a carbon material for reference example 2.

### Comparative Example 1 (Heat Treated Carbon Material at 700° C.)

Green cokes having particle diameter of about 13 μm were heat treated at 700° C. for 8 h in N₂ to form a carbon material for comparative example 1.

### Comparative Example 2 (Boron Doped Carbon Material)

Green cokes having particle diameter of about 13 μm and boric acid were mixed in a mole ratio of 1:0.17 and the resultant mixture was heat treated at 1000° C. for 2 h in N₂, the material was washed with water and dried in a vacuum oven for 24 h to prepare a carbon material for comparative example 2.

### Example 1 (Multi-Channel B Doped Carbon Material)

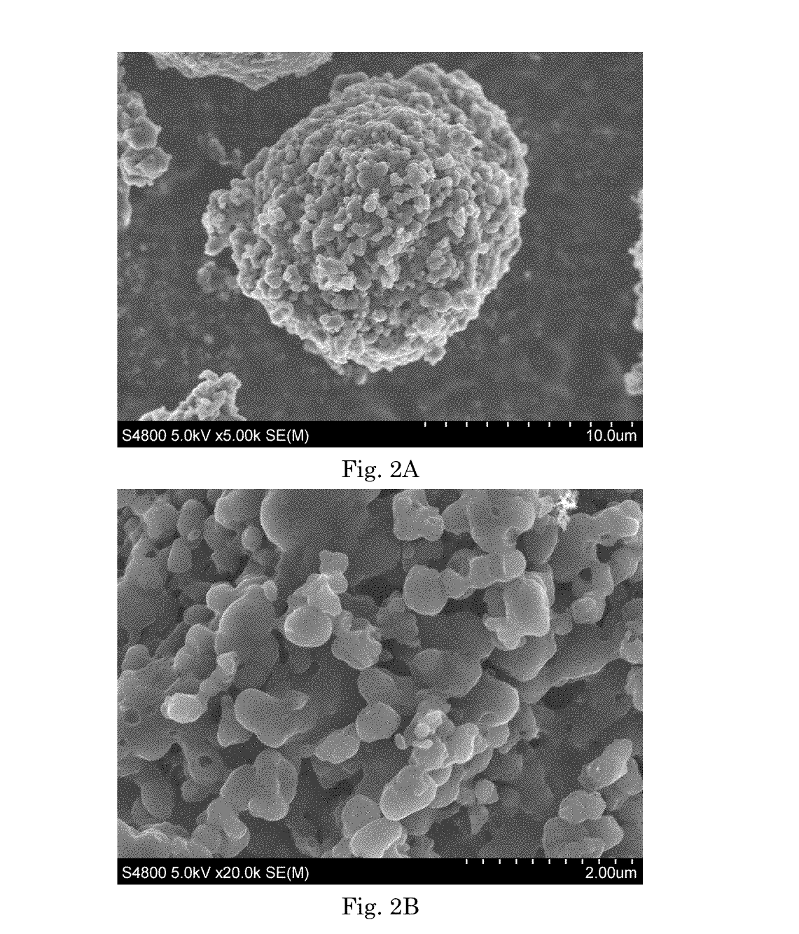

Green cokes having particle diameter of about 13 μm were firstly heat treated at 650° C. in air for 1 h and then mixed with 0.17 mole of boric acid per 1 mole of the green cokes. The resultant mixture was heat treated firstly at 300° C. for 2 h, then at 600° C. for 2 h, and finally at 700° C. for 4 h. The materials were washed with water and dried in vacuum oven for 24 h to prepare a carbon material for example 1. SEM images of the carbon material are shown in FIGS. 2A (5,000 magnifications) and 2B (20,000 magnifications). The surface of the carbon material was etched by air oxidation and a multi-channel structure (holes or pores) was fabricated.

Results of elemental analysis, average depth of pores or holes and interlayer space for carbon materials in reference examples 1-2, comparative examples 1-2 and example 1 are shown in Table 1.

TABLE 1

| | | | | | | Average | |
|---|---|---|---|---|---|---|---|
| | | | | | | depth | |
| | | | | | | of pores | Interlayer |
| Carbon | Elemental analysis (wt %) | | | | | or holes | space |
| material | C | N | H | O | B | (nm) | (nm) |
| Reference | 78.4 | 1 | 1.9 | 14.6 | — | — | — |
| Example 1 | | | | | | | |
| Reference | 99.9 | <0.3 | <0.3 | 0.4 | — | — | 0.335 |
| Example 2 | | | | | | | |
| Comparative | 94.4 | 0.9 | 1.3 | 1.5 | — | 25 | 0.345 |
| Example 1 | | | | | | | |
| Comparative | 91.2 | 0.9 | 1.3 | 1.8 | 1.87 | — | 0.344 |
| Example 2 | | | | | | | |
| Example 1 | 89.3 | 0.7 | 0.5 | 3.4 | 1.99 | 600 | 0.348 |

### Fabrication of Cell

The carbon material, carbon black, carboxymethyl cellulose (CMC) and styrene-butadiene rubber (SBR) were mixed in a weight ratio of 91:3:4:2. The resultant mixture was dispersed in pure water to prepare negative slurry.

The negative slurry was coated on a Cu foil as a current collector, dried at 120° C. for 15 min, pressed to 45 μm thick with a load of 80 g/m² and cut into 22×25 mm to prepare a negative electrode. The negative electrode as a working electrode and a metal lithium foil as a counter electrode were stacked by interposing porous polypropylene film therebetween as a separator. The resultant stack and an electrolyte prepared by dissolving 1M LiPF₆ in a mixed solvent of ethylene carbonate (EC) and diethyl carbonate (DEC) with a volume ratio of 3:7 were sealed into an aluminum laminate container to fabricate a test cell. The negative electrode was also stacked with a positive electrode to fabricate a full cell. The positive electrode was prepared by coating a cathode slurry made of lithium iron phosphate, carbon black, PVDF with the weight ratio of 87:6:7 on Al foil.

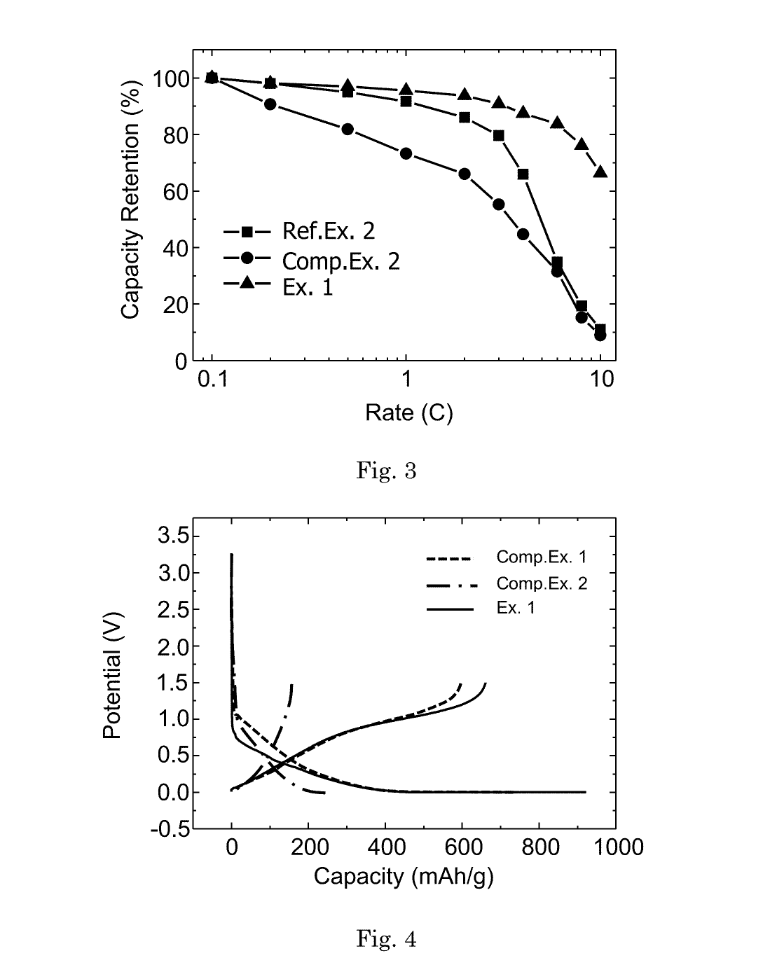

The test cell was evaluated in initial charge capacity, efficiency, rate capability and cyclability. FIG. 3 shows a graph of rate capabilities of test cells using carbon materials of reference example 2, comparative example 2 and example 1. Example 1 (multi-channel B doped carbon material) shows better rate capability than reference example 2 (conventional graphite). In case of comparative example 2, although the carbon material has been doped with boron, the rate capability is the worst because of larger interlayer spaces. FIG. 4 shows charging and discharging curves of the test cells in Comparative Examples 1 and 2, and Example 1. Example 1 (multi-channel B doped carbon material) shows an excellent charging capacity.

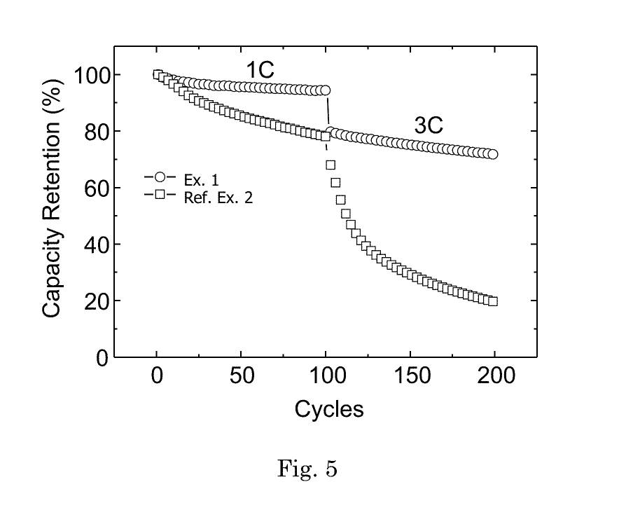

Cyclabilities of full cells in Example 1 and reference example 2 are shown in FIG. 5. Cyclability was evaluated at 1C-charge/0.1C-discharge for the first 100 cycles and 3C-charge/0.1C-discharge for the next 100 cycles. As shown in FIG. 5, conventional graphite (Reference Example 2) was deteriorated the cyclability, particularly 3C cyclability. On the other hand, multi-channel B doped carbon material (Example 1) showed excellent cyclability.

Capacity, coulombic efficiency and rate capability of each carbon material in full cell are summarized in Table 2.

TABLE 2

| | | | Rate capability | | |
|---|---|---|---|---|---|
| | | Coulombic | (capacity retention (%)) | | |
| Carbon | Capacity | efficiency | 1 C/ | 6 C/ | 10 C/ |
| material | (mAh/g) | (%) | 0.1 C | 0.1 C | 0.1 C |
| Reference | 14 | 5 | — | — | — |
| example 1 | | | | | |
| Reference | 365 | 93 | 92 | 35 | 11 |
| example 2 | | | | | |
| Comparative | 324 | 74 | 94 | 70 | 34 |
| Example 1 | | | | | |
| Comparative | 432 | 75 | 94 | 72 | 40 |
| Example 2 | | | | | |
| Example 1 | 668 | 72 | 94 | 86 | 66 |

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. A process for manufacturing an anode material for a lithium ion battery comprising:
preparing a raw material of the anode material selected from high oxygen containing carbons;
heat treating the raw material at a temperature ranging from 550° C. to 850° C. under oxidizing atmosphere to form a multi-channel carbon material; and
doping boron into the multi-channel carbon material.

2. The process as claimed in claim 1, wherein the doping boron into the multi-channel carbon material comprises mixing the multi-channel carbon material with a boron containing compound in a mole ratio of 1:0.5 to 1:1 and then heat treating under a nitrogen atmosphere.

3. The process as claimed in claim 2, wherein the heat treating comprises a first heating step at a temperature ranging from 250° C. to 350° C., a second heating step at a temperature ranging from 400° C. to 650° C. and a third heating step at a temperature ranging from 650° C. to 900° C.

4. An anode material for a lithium-ion battery comprising a carbon material, wherein
the carbon material comprises a plurality of pores or holes with the depth between 100 nm and 3 μm inclusive on the surface;
the carbon material is doped with 0.5 to 5% by weight of borons; and
the carbon material has an interlayer space between 0.3470 nm and 0.36 nm inclusive.

5. The anode material as claimed in claim 4, wherein the particle size of the carbon material is from 10 μm to 25 μm.

6. The anode material as claimed in claim 4, wherein the doped boron is implanted in a region deeper than 50 nm from the uppermost surface of the carbon material.

7. The anode material as claimed in claim 4, wherein the carbon material is coated with amorphous carbon at the thickness from 2 nm to 15 nm.

8. An anode material for a lithium-ion battery comprising the carbon material obtained by the method according to claim 1.

9. A lithium ion battery comprising positive and negative electrodes, the negative electrode comprises the anode material according to claim 4.

10. The lithium ion battery as claimed in claim 9, wherein the anode material has at least 500 mAh/g of capacity.

11. An anode material for a lithium-ion battery comprising the carbon material obtained by the method according to claim 2.

12. A lithium ion battery comprising positive and negative electrodes, the negative electrode comprises the anode material according to claim 5.

13. The lithium ion battery as claimed in claim 12, wherein the anode material has at least 500 mAh/g of capacity.

14. An anode material for a lithium-ion battery comprising the carbon material obtained by the method according to claim 3.

15. A lithium ion battery comprising positive and negative electrodes, the negative electrode comprises the anode material according to claim 6.

16. The lithium ion battery as claimed in claim 15, wherein the anode material has at least 500 mAh/g of capacity.

17. A lithium ion battery comprising positive and negative electrodes, the negative electrode comprises the anode material according to claim 7.

18. The lithium ion battery as claimed in claim 17, wherein the anode material has at least 500 mAh/g of capacity.
